(19) United States
(12) Patent Application Publication
(10) Pub. No.: US 2008/0167204 A1
(43) Pub. Date: Jul. 10, 2008

(54) Process for Enhancing Fluid Hydration

(76) Inventors: Billy Ray Slabaugh, Duncan, OK (US); Jimmy Weaver, Duncan, OK (US)

Correspondence Address: JOHN W. WUSTENBERG, P.O. BOX 1431, DUNCAN, OK, 73536, US

(21) Appl. No.: 11/621,407

(22) Filed: Jan. 9, 2007

(51) Int. Cl. C09K 3/00

(52) U.S. Cl. 507/214; 507/200; 507/211; 507/219

(57) ABSTRACT

A method of enhancing hydration of a hydratable material is described, including providing an aqueous composition including a hydratable material, and supplying energy to the aqueous composition using a cavitation device.

### TECHNICAL FIELD

The present invention relates generally to fluid hydration, including the hydration of fracturing fluids.

### BACKGROUND

Various hydratable materials may be used to viscosity fracturing fluids. The hydratable material selected for a particular use may be based on a number of factors, including the rheoulogical properties, economics, and hydration ability of the material. The term “hydration” is used to described the process wherein the hydratable material solvates or absorbs water (hydrates) and swells in the presence of water.

The use of a hydratable material in fracturing fluids often requires the construction and maintenance of hydration tanks. The use of hydration tanks is generally necessary to allow sufficient time to prepare a fracturing fluid for use, including allowing a hydratable material sufficient time to hydrate. Thus, the hydratable material is typically mixed with water and allowed to hydrate in a hydration tank before use. These tanks are typically located near where the fracturing fluid is used. Alternatively, tanker trucks may be used to transport the fluids to the location of use. Once the hydratable material has hydrated (generally forming a gel) the hydrated material may be used as a component in a fracture stimulation fluid. There are many costs associated with such an approach, including the cost of the tank, the cost of transporting and using the hydration tank, and the disposal costs associated with any excess hydration mixture (which typically must be disposed in an environmentally safe manner).

### SUMMARY

In one aspect, a method of enhancing hydration of a hydratable material is described, including providing an aqueous composition including a hydratable material, and supplying energy to the aqueous composition using a cavitation device. Variously, the concentrating of hydratable material in the aqueous composition may be at least about 40 pounds per 1000 gallons, at least about 100 pounds per 1000 gallons, or at least about 200 pounds per 1000 gallons.

The method may also include adding aqueous fluid to the composition after supplying energy to the composition in order to dilute the aqueous composition to obtain a final desired gel concentration. The final desired gel concentration may be from about 10 pounds to about 120 pounds per 1000 gallons of fluid, or may be from about 15 pounds to about 60 pounds per 1000 gallons of fluid.

Variously, the concentration of hydratable material in the aqueous composition may be at least twice the final desired gel concentration, may be at least four times the final desired gel concentration, or may be at least ten times the final desired gel concentration. Variously, the hydratable material may include a polymer, a synthetic polymer, a galactomanan, a polysaccharide, a cellulose, or a clay.

In another aspect, a method of enhancing hydration of a hydratable material is described, including providing an aqueous composition including a hydratable material; supplying energy to the aqueous composition using a cavitation device; and diluting the aqueous composition following cavitation to obtain a final fluid having a desired gel concentration. The aqueous composition may have a concentration of hydratable material from about 100 pounds per 100 gallons to about 500 pounds per 1000 gallons. The final fluid may have a gel concentration from about 15 pounds to about 60 pounds per 1000 gallons.

In another aspect, a method of hydrating a hydratable material is descried, wherein the improvement includes using a cavitation device to supply energy to an aqueous composition including a hydratable material. The hydratable material may include a galactomanan.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a graph showing the viscosity and temperature of a composition over time by passing the composition through a cavitation device at various rpm.

FIG. 2 is a graph showing the % hydration over time of compositions having different initial concentrations passed through a cavitation device and diluted to a final gel concentration of approx. 40 pounds per 1000 gallons.

### DETAILED DESCRIPTION

A cavitation device may be used to decrease the time required to hydrate a hydratable material. A composition including a hydratable material and water is prepared and fed to a cavitation device. The composition may be mixed prior to entry into the cavitation device, or may be mixed at the point of entry. As the composition passes through the cavitation device, energy is supplied to the composition via cavitation. This supply of energy acts to enhance the rate of hydration of the hydratable material in the composition. The hydrated composition may be used for a variety of purposes, such as use in fracturing fluids, use in other drilling fluids, etc.

Although the composition typically only spends a short period of time in the cavitation device, this time is sufficient to impart energy to the hydratable material and begin hydration. In some cases, the composition may only be present in the cavitation device for a few seconds before exiting the cavitation device. After exiting the cavitation device, hydration of the datable material continues until the hydratable material is fully hydrated. Generally, most of the hydration will occur after hydratable material exits the cavitation device. In general, the energy imparted to the composition by cavitation improves the hydration rate of the hydratable material compared to the baseline rate for that hydratable material.

As hydration typically occurs after the composition exits the cavitation device, such as in the piping following cavitation, there is not need for storage tanks to hold a hydrated composition to allow hydration to occur, though storage tanks may still be used in desired. In addition, the hydratable material may be hydrated closer to the actual time of use. For these reasons, the amount of excess hydrated material produced may be minimized. An addition advantage is that water (with no additional disposal costs) is sorted prior to use, rather than storing a mixed composition (which has additional disposal costs).

The hydratable material may be various materials, including natural materials, modified materials, inorganic materials, organic materials, synthetic materials, and combinations thereof.

In one embodiment, the hydratable material used may include natural and devitalized hydratable polymers, such as olysaccharides, biopolymers, and other polymers. Examples of polymers that may be used include arabic gums, cellulose, karaya gums, xanthan, tragacanth gums, ghatti gums, carrageenin, psyllium, acacia gums, tamarind gums, guar gums, locust bean gums, and the like. Modified gums including carboxyalkyl derivatives such as carboxymethyl guar, and hydroxyalkyl derivatives such as hydroxyprpyl guar, can also be employed. Doubly derivatized gums such as carboxymethylhydroxypropyl guar (CMHPG) can also be used. Generally, carboxyalkylguar, carboxdyalkylhydroxyalkylguar, and the like may be used, wherein the alkyl groups may comprise methyl, ethyl or propyl groups. In some embodiments, galactomanans such as guar, including natural, modified, or derivative galactomanans, may be used.

In one embodiment, the hydratable material used may include a cellulose. Examples of celluloses, modified celluloses, and cellulose derivatives that may be used include cellulose, cellulose ethers, esters, and the like. For example, generally any of the water-soluble cellulose ethers can be used. Those cellulose ethers include, among others, the various carboxyalkylcellulose ethers, such as carboxyethylcellulose and carboxymethylcellulose (CMC); mixed ethers such as carboxyalkylethers, e.g., carboxymethylhydroxyethylcellulose (CHHEC); hydroxyalkylcelluloses such as hydroxyethylcellulose (HEC) and hydroxypropylcellulose; alkylhydroxyalkylcelluloses such as methylhydroxypropylcellulose; alkylcelluloses such as methylcellulose, ethylcellulose and propylcellulose; alkylcarboxyalkylcelluloses such as ethylcarboxymethylcellulose; alkylalkylcelluloses such as methylethylcellulose; hydroxyalkylalkylcelluloses such as hydroxypropylmethylcellulose; and the like. Generally, carboxyalkylcellulose, carboxyalkylhydroxyalkylcellulose and the like maybe used, wherein the alkyl groups may comprise methyl, ethyl or propyl groups. In addition, derivatized celluloses, such as a hydroxyethylcellulose grafted with vinyl phosphoric acid may be used.

In one embodiment, the hydratable material used may include hydratable clays. Examples of hydratable clays that may be used include bentonite, montmorillonite, laponite, and the like.

In one embodiment, the hydratable material used may include hydratable synthetic polymers. Examples of hydratable synthetic polymers and copolymers which can be utilized include, but are not limited to, polyacrylate, polymethacrylate, acrylamide-acrylate copolymers and maleic anhydride methylvinyl ether copolymers.

The hydratable material may be provided in a variety of forms. For example, the hydratable material may be provided in a variety of forms. For example, the hydratable material may be in powder form (“flour”), or may be a powder suspended in oil. Generally, a hydratable material suspended in oil may be referred to as a liquid gel concentrate (“LGC”).

The hydratable material may be mixed with an aqueous fluid using any suitable mixing apparatus or method prior to being fed to a cavitation device. For example, the hydratable material may be mixed together with an aqueous fluid using an in-line mixer prior to feeding to a cavitation device. In another example, the hydratable material may be mixed together with an aqueous fluid via injection into an aqueous fluid stream just prior to feeding to a cavitation deice. Other methods of combining the hydratable material and the aqueous fluid may also be used.

A wide range of hydratable material concentrations may be used in forming the starting composition that is passed through the cavitation device. In various embodiments, the hydratable material may be present in the composition passed through the cavitation device at a concentration of 1 pound per 1000 gallons or more, 10 pounds per 1000 gallons, or more, 20 pounds per 1000 gallons or more, 40 pounds per 1000 gallons or more, 100 pounds per 1000 gallons or more, 200 pounds per 1000 gallons, or 300 pounds per 1000 gallons or more. Generally, the hydratable material may be present in the composition fed to the cavitation device at very high concentration levels, for example, up to 500 pounds per 1000 gallons or even higher. Typically, the concentration of hydratable material fed to the cavitation device may vary based on a number of factors that may include the hydratable material selected, the final desired concentration, the post-cavitation dilution, the flow rate needed, etc.

In one embodiment, the hydratable material has a concentration in the composition fed to the cavitation device that is equal to the final desired concentration. For example, if a 40 pounds per 1000 gallon fracturing fluid composition is desired for use, sufficient hydratable material may be added to the starting composition to form a 40 pounds per 1000 gallon final concentration in the fracturing fluid after hydration. As another example, if a 100 pounds per 1000 gallon fracturing fluid composition is desired for use, sufficient hydratable material may be added to the starting composition to form a 100 pounds per 1000 gallon fracturing fluid after hydration. Increasing the amount of hydratable material present in the composition will typically increase the viscosity of the finished fluid following hydration. In like manner, therefore, sufficient hydratable material may be added to the starting composition to obtain the desired final fracturing fluid gel concentration.

In another embodiment, the concentration of hydratable material in the starting composition may be greater than the desired concentration for the final composition. A starting composition having a higher concentration of hydratable material may be diluted after cavitation to produce a finished fluid having a viscosity suitable for use in the desired application. For example, if a 40 pound per 1000 gallon final concentration fluid is desired, a starting composition including sufficient hydratable material to have 200 pounds per 1000 gallon concentration may be produced and passed through a cavitation device. Following cavitation, the composition may be diluted with sufficient water to produce a fluid having a final gel concentration of 40 pounds per 1000 gallons. In another embodiment, if a 20 pounds per 1000 gallon final concentration fluid is desired, a starting composition including sufficient hydratable material to have a concentration of 400 pounds per 1000 gallons may be produced and passed through a cavitation device. Following cavitation, the composition of 20 pounds per 1000 gallons. In other embodiments, other starting and final concentrations are used. In general, a concentrated starting composition may be formed and subjected to cavitation, and then diluted with sufficient fluid to result in a final composition having the desired final concentration. Generally, the dilution fluid may be an aqueous fluid.

Various measurements may be performed during processing. These may be carried out to assist in measuring and managing the cavitation and mixing process. For example, the viscosity of the composition may be measured upon exiting the cavitation device. Generally, water and/or other components may be added to dilute the composition after exiting the cavitation device. This addition/dilution may be done based upon a calculated desired concentration target, on a viscosity reading, or on other factors.

Generally, the hydratable material may be fully hydrated to become a hydrated material that forms a gel in the final fluid. Typically, the amount of hydrated material (from the hydratable material) employed in the final aqueous gel depends upon the desired viscosity of the aqueous gel. The hydrated material (from the hydratable material) generally is present in the final fluid in a concentration of from about 10 pounds to about 120 pounds per 1000 gallons of fluid. In some embodiments, the hydrated material (from the hydratable material) may be present in the final fluid in a concentration of from about 15 pounds to about 60 pounds per 1000 gallons of fluid. Hydration, or salvation, of the gelling agent in the mixing apparatus generally results in the formation of a gel in the final composition. Thus, the final hydrated material concentration (from the hydratable material) may also be referred to as a gel concentration.

The starting composition may be formed and passed through the cavitation device to produce a finished composition as needed, or the composition may be produced and stored for later use. For example, as fracture stimulating fluid is needed for pumping into a well, a starting composition may be produced, subjected to cavitation, diluted if desired, and hydrated for use in the fracture fluid. The hydration may finalize in the piping before pumping into a subterranean formation. Alternatively, a designated amount of composition may be produced, passed through a cavitation device, and stored for later use, and hydrating may finalize in a storage tank.

### EXAMPLES

### Example 1

An in-line mixer was used to form a composition including water and guar. Water was fed to the mixer at a rate of 0.5 gallons per minute, and a sufficient amount of guar (a galactomanan) in the form of a liquid gel concentrate (“LGC”) was added to produce a composition having a guar concentration of 40 pounds per 1000 gallons. The guar used was WG-22 (Halliburton, Houston, Tex.). Thus, enough LGC was added to produce a composition including approximately 0.48% by weight guar (or 40 pounds per 1000 gallons).

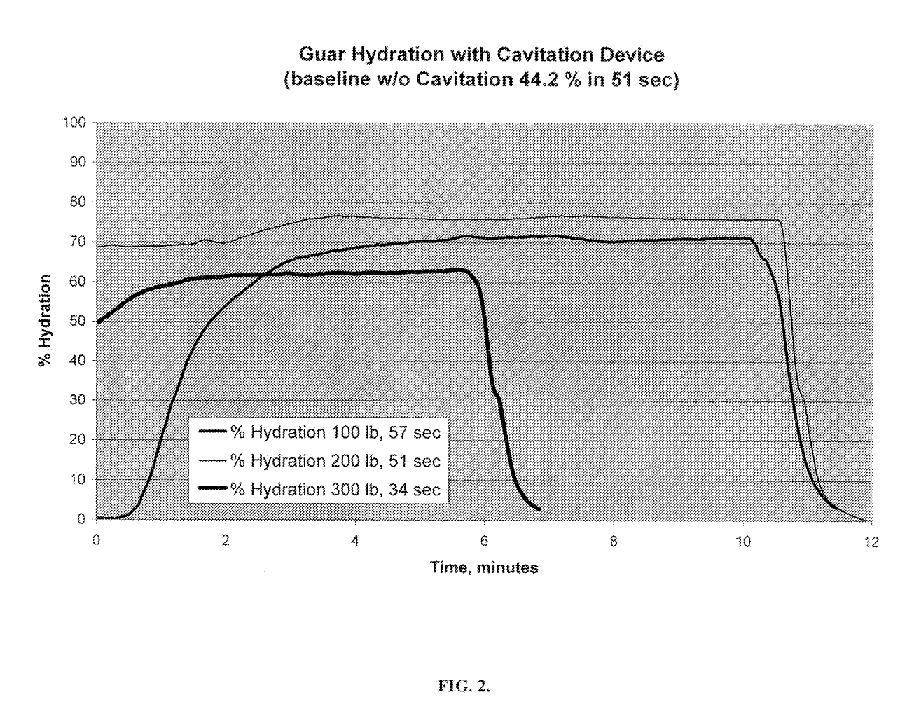

The composition was fed from the in-line mixer into a Shock Wave Power Reactor™ (“SPR”) (available from Hydro Dynamics, Inc., Rome, Ga.). The results are shown graphically in FIG. 2. After allowing an equilibrium time of 5 minutes for the SPR during which only water was fed through the mixer and cavitation device, the LGC supply was turned on (noted on chart). The viscosity began to increase immediately. The rpm settings on the SPR were adjusted as follows (and noted on the chart):

| Time (min) | RPM |
|---|---|
| 0 | 0 |
| 15 | 900 |
| 27 | 1800 |
| 35 | 3600 |

The viscosity of the composition was measured as it exited the SPR using an in-line viscosity instrument (Brookfield TT100, available from Brookfield Engineering Laboratories, Middleboro, Mass.). The temperature of the composition was measured in the cavitation chamber by a thermocouple attached to the SPR.

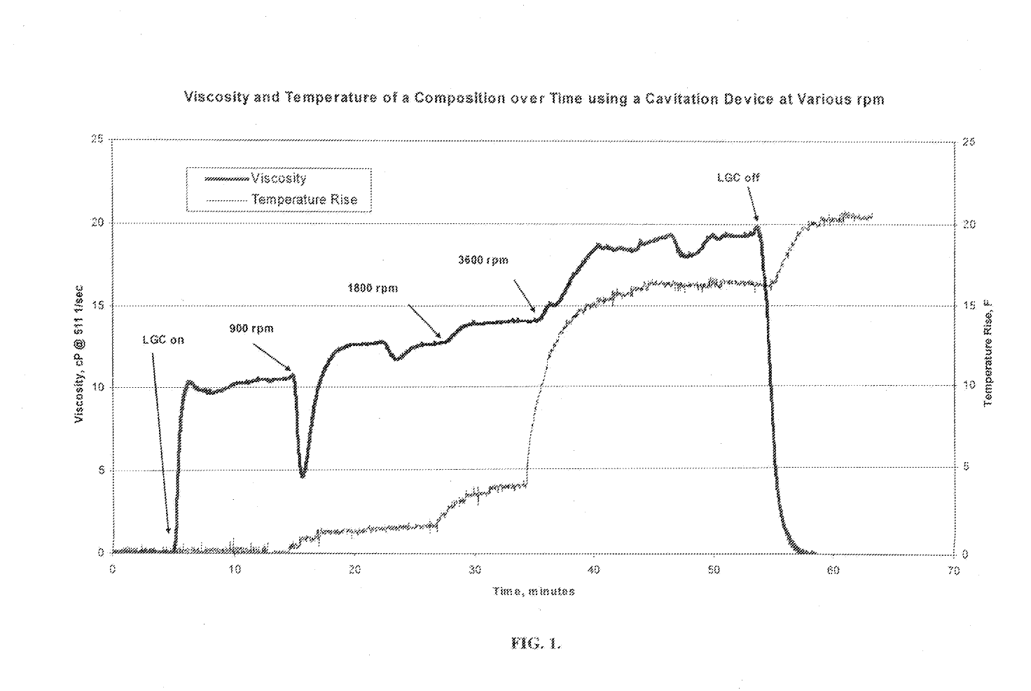

Both the viscosity and temperature are shown graphically against time in FIG. 1, with significant changes of conditions (started and stopping addition of the guar via LGC, and rpm changes) noted in the graph.

### Example 2

The procedure of Example 1 was followed, with the exception that a sufficient amount of guar was added to produce an initial composition having a guar consecration of 100 pounds per 1000 gallons. In addition, the LGC was added immediately at the entry of an in-line mixer, forming the composition, which was then passed through the cavitation device. The initial composition was passed through the cavitation device (run at a rate of 3600 rpm) at 0.5 gallons/minute. As the composition left the cavitation device, it was diluted (at a second pump supplying water) to produce a final fluid having a guar concentration of approx. 40 pounds per 1000 gallons.

The % hydration of the guar composition against time is shown in FIG. 2. The time was measured beginning from the point at which the gel was mixed with the water at the in-line mixer to the point at which the composition reached the viscometer. Accordingly, samples for the composition were measured 57 seconds after mixing, as it required 57 seconds for the composition to reach the viscometer, given the flow rates and pipe length used. After the cavitation device stabilized, the % hydration of the composition continued to be relatively constant until the SPR was turned off at about 11 minutes and the run ended.

For comparison, an initial composition having a concentration of 100 pounds per 1000 gallons was treated in the same manner, including dilution to a 40 pounds per 1000 gallon final concentration, except that the composition did not pass through an operating cavitation device. This composition was 44.2% hydrated 51 seconds after mixing.

### Example 3

The experiment of Example 2 was repeated, except that the composition included a sufficient amount of guar to produce an initial composition having a guar concentration of 200 pounds per 1000 gallons. Again, the composition was diluted following cavitation to a final concentration of approx. 40 pounds per 1000 gallons. Due to the increased dilution and corresponding increased flow, pipe was added between the dilution pump and the viscometer. However, as the flow changed, the time decreased slightly even with the additional pipe used. Therefore, samples were measured 51 seconds after initial guar/water mixing.

FIG. 2 also shows the % hydration of the composition over time. As with Example 2, there was a short period until stabilization of the cavitation device was reached, after which the % hydration of the composition continued to be relatively stable until the SPR was turned off after about 11 minutes and the run ended.

### Example 4

The experiment of Example 2 was repeated, except that the composition included a sufficient amount of guar to produce an initial composition having a guar concentration of 300 pounds per 1000 gallons. The composition was diluted following cavitation to a final concentration (or gel composition) of approx. 40 pounds per 1000 gallons. Once again, due to the increase dilution and corresponding increased flow, pipe was added between the dilution pump and the viscometer. However, there was insufficient space and piping to fully equalize the time, and the age in seconds varied with the increased dilution rate. Thus, samples were measured 31 seconds after initial guar/water mixing.

FIG. 2 also shows the % hydration of the composition over time. As with the previous examples, there was a short period until cavitation stabilization is reached, after which the % hydration of the composition continued to be relatively stable until the SPR was turned off after about 6 minutes and the run ended.

A number of embodiments of the invention have been described. Nevertheless, it will be understood that various modifications may be made without departing from the spirit and scope of the invention. Accordingly, other embodiments are within the scope of the following claims.

What is claimed is:

1. A method of enhancing hydration of a hydratable material, comprising:
providing an aqueous composition including a hydratable material; and
supplying energy to the aqueous composition using a cavitation device.

2. The method of claim 1, wherein the concentration of hydratable material in the aqueous composition is at least about 40 pounds per 1000 gallons.

3. The method of claim 1, wherein the concentration of hydratable material in the aqueous composition is at least about 100 pounds per 1000 gallons.

4. The method of claim 1, wherein the concentration of hydratable material in the aqueous composition is at least about 200 pounds per 1000 gallons.

5. The method of claim 1, further comprising adding aqueous fluid to the composition after supplying energy to the composition in order to dilute the aqueous composition to obtain a final desired gel concentration.

6. The method of claim 5, where the concentration of hydratable material in the aqueous composition is at least twice the final desired gel concentration.

7. The method of claim 5, wherein the concentration of hydratable material in the aqueous composition is at least four times the final desired gel concentration.

8. The method of claim 5, wherein the concentration of hydratable material in the aqueous composition is at least ten times the final desired gel concentration.

9. The method of claim 5, wherein the final desired gel concentration is from about 10 pounds to about 120 pounds per 1000 gallons of fluid.

10. The method of claim 5, wherein the final desired gel concentration is from about 15 pounds to about 60 pounds per 1000 gallons of fluid.

11. The method of claim 1, wherein the hydratable material comprises a polymer.

12. The method of claim 1, wherein the hydratable material comprises a synthetic polymer.

13. The method of claim 1, wherein the hydratable material comprises a galactomanan.

14. The method of claim 1, wherein the hydratable material comprises a polysaccharide.

15. The method of claim 1, wherein the hydratable material comprises a cellulose.

16. The method of claim 1, wherein the hydratable material comprises a clay.

17. A method of enhancing hydration of a hydratable material, comprising:
providing an aqueous composition including a hydratable material;
supplying energy to the aqueous composition using a cavitation device; and
diluting the aqueous composition following cavitation to obtain a final fluid having a desired gel concentration.

18. The method of claim 17, wherein the aqueous composition has a concentration of hydratable material from about 100 pounds per 1000 gallons to about 500 pounds per 1000 gallons.

19. The method of claim 17, wherein the final fluid has a gel concentration from about 15 pounds to about 60 pounds per 1000 gallons.

20. A method of hydrating a hydratable material, wherein the improvement comprises using a cavitation device to supply energy to an aqueous composition including a hydratable material.

21. The method of claim 20, wherein the hydratable material comprises a galactomanan.
